(19) United States
(12) Patent Application Publication
(10) Pub. No.: US 2005/0030574 A1
(43) Pub. Date: Feb. 10, 2005

(54) Print job re-routing scheme

(75) Inventors: Andrew S. McVey, Huntington Beach, CA (US); Maomi M. Ryono, Manhattan Beach, CA (US)

Correspondence Address: PAUL J MAGINOT;MAGINOT MOORE & BECK LLP, BANK ONE CENTER/TOWER, 111 MONUMENT CIRCLE SUITE 3000, INDIANAPOLIS, IN, 46204, US

(73) Assignee: Xerox Corporation.

(21) Appl. No.: 10/635,673

(22) Filed: Aug. 6, 2003

(51) Int. Cl. G06F 3/12; G06F 15/173; G06F 15/00

(52) U.S. Cl. 358/1.14; 709/239; 710/38; 358/1.15

(57) ABSTRACT

A print job handling system, the system at least includes: a network adapted to interconnect at least one computer and peripheral devices; a plurality of network printers coupled to the network, and adapted to execute print jobs; and at least one printer control panel coupled to at least one of the network printers; wherein the control panel at least includes a control panel display adapted to display information about currently pending print jobs that have been sent to the control panel's associated network printer, along with an indication of the ability of the control panel's associated network printer to execute pending print jobs; and wherein the control panel at least includes an input mechanism adapted to allow a network user to, via the control panel and upon an indication that a print job cannot be executed or executed satisfactory to the user, re-route a print job from the control panel's associated printer to an alternate network printer.

### 1. FIELD OF THE INVENTION

The present invention generally relates to networked printers. More specifically, the present invention relates to efficiently and robustly handling print jobs.

### 2. BACKGROUND OF RELATED ART

Networked printers are common in corporate computing environments. The networked approach allows computer users to share printing resources so that there is no need to supply each user with an expensive printer. Further, the networked approach allows print jobs to be executed at more than one location in an office, according to the geographic and specific print job needs of the users.

An added benefit of having multiple network printers is a degree of redundancy that allows print jobs to be executed at more than one location, and to the satisfaction of the user. This can be a valuable feature of the networked approach when one or more of the network printers are incapacitated, overwhelmed, or not able to execute a print job according to a particular user's specification or time frame. The inability to execute a print job can result from a variety of problems, including for example, insufficient or incompatible paper, insufficient toner or ink, paper jams, and printer malfunction or failure. U.S. Patent Application Number 880023/09 filed Jun. 6, 2001 in the name of John D. Laughlin for “Printer-Embedded Service to Allow for Fail-Over Operation Through Automatic Rerouting of Print Jobs to Comparable Printers,” describes a scheme for automatically re-routing a print job when the printer chosen for executing the print job cannot execute the job. That is,
[a] printer that is out of service would contain an embedded service that would communicate with a network directory service to locate another printer capable of completing the print job and rerouting the print job automatically. This embedded service within the printer would then communicate with the print server to notify the user of the rerouting.

Also using an automatic re-routing approach is U.S. Patent Application Number 108870/10 filed Mar. 29, 2002 in the name of Hironobu Ishida for “Printing Service System.” The abstract of that application states:
At the time of placing an order for printing image data via a network, the order can be efficiently rerouted in the case where a printing service provider designated according to an agency specified by a user cannot process the order. A database in a service center stores a laboratory information table. The printing service provider registers with the laboratory information table in advance the printing services available thereat and rerouting information to automatically send order information representing processing that cannot be processed by the printing service provider, such as large-size printing and postcard printing, to another printing service provider. An order reception server judges the content of order information sent from the user and sends the order information to the printing service provider designated by the rerouting information in the laboratory information table if necessary.

A further automatic re-routing approach is disclosed in U.S. Pat. No. 6,529,286, issued Mar. 4, 2003 to Edward W. King for “Dynamic Printing Interface for Routing Print Jobs in a Computer Network.” The abstract of that patent states:
A dynamically shared printing interface (DDSPI) in a computer network that routes print jobs to printers in a user defined preferred printer list (PPL) based upon a printer's capability to print a certain job when the print job is requested. A user sends a print job to the DDSPI that calculates the estimated workload to print the job designated as a task allocation property (TAP), sends a multi-cast to the printers in the PPL requesting printer capability information designated as a printer power index (PPI), receives the PPI from the printers in the PPL that calculate their own capability, compares the PPI with the TAP, routes the print job whose PPI best matches with the TAP and notifies the user of the printer to which the job is routed. The printers in the PPL calculate their own PPI's based upon the printer engine speed, printer memory size, number, size and complexity of print jobs waiting in the printer queue at the instance the multi-cast is received. In another aspect the DDSPI re-routes a print job if the original printer develops an error and cannot print the job, by re-sending a multi-cast to the other printers in the PPL requesting printer PPI's, receiving PPI's from the printers that re-calculate their PPI, compare the TAP with the resent PPI's, re-route the print job whose PPI best matches the TAP and re-notify the user of the printer to which the job is re-routed.

The idea of automatic re-routing has also been applied to networked facsimile machines (or machines capable of reproducing facsimile transmissions) in U.S. Patent Application Number 725127/09 filed Nov. 29, 2000 in the name of Satoshi Yashiki for “Internet Facsimile System.”

None of the prior art approaches adequately addresses the problems encountered by users when they send print jobs to a remotely located printer which appears capable of executing the job at the time the job is sent, and the printer subsequently becomes incapable of executing the print job once the user has arrived at the printer location. While some prior art teaches automatically re-routing print jobs when the first printer is perceived to have become incapable of executing the print jobs, the user has no control over the operation at the point of the printer. Not only does the user not determine whether the print job is re-routed, but he or she also has no control over where the print job is re-routed. The prior art automatic re-routing operation can be caused by a perceived (by the system) crowded print job queue that may in fact be acceptable (the wait) for the user.

Another prior art solution is the cumbersome approach requiring the user to walk back to the computer from which the print job was sent, and then resend the print job to another printer. It may also be required that he or she cancel the previously sent print job.

What is therefore greatly needed, is an improved, flexible scheme for handling print jobs in a printer network in which, in the physical presence of a printer via a control panel, a user can choose whether to re-route print jobs that have previously been sent to the printer in question if either the print jobs cannot be executed, or they cannot be executed during the user's preferred time frame. It is also desirable that the user have the option to choose which network printer will receive the re-routed print job.

### SUMMARY

In view of the above-identified problems and limitations of the prior art, the present invention provides a print job handling system at least including a network adapted to interconnect at least one computer and peripheral devices, a plurality of network printers coupled to the network, and adapted to execute print jobs, and at least one printer control panel coupled to at least one of the network printers. The control panel at least includes a control panel display adapted to display information about currently pending print jobs that have been sent to the control panel's associated network printer, along with an indication of the ability of the control panel's associated network printer to execute pending print jobs. The control panel also at least includes an input mechanism adapted to allow a network user to, via the control panel and upon an indication that a print job cannot be executed or executed satisfactory to the user, re-route a print job from the control panel's associated printer to an alternate network printer.

The present invention also provides a print job handling method at least including: via a network, interconnecting at least one computer and peripheral devices; coupling to the network, a plurality of network printers adapted to execute print jobs; via a control panel coupled to at least one of the network printers, displaying information about currently pending print jobs that have been sent to the control panel's associated network printer, along with an indication of the ability of the control panel's associated network printer to execute pending print jobs; and via the control panel, and upon an indication that a print job cannot be executed or executed satisfactory to the user, allowing a user to re-route a print job from the control panel's associated printer to an alternate network printer.

### BRIEF DESCRIPTION OF THE DRAWINGS

Features of the present invention will become apparent to those skilled in the art from the following description with reference to the drawings, in which:

FIG. 1 is a general schematic diagram of the novel print job handling network of the present invention; and

FIG. 2 is a flowchart detailing the steps employed by the present-inventive print job handling method; and

FIG. 3 a control panel scheme compatible with the present-inventive print job handling method.

### DETAILED DESCRIPTION

The term “printer” refers, for example, to reproduction devices in general, such as printers, facsimile machines, and copiers, and the term “print job” refers, for example, to information including the electronic item or items to be reproduced.

General System Description

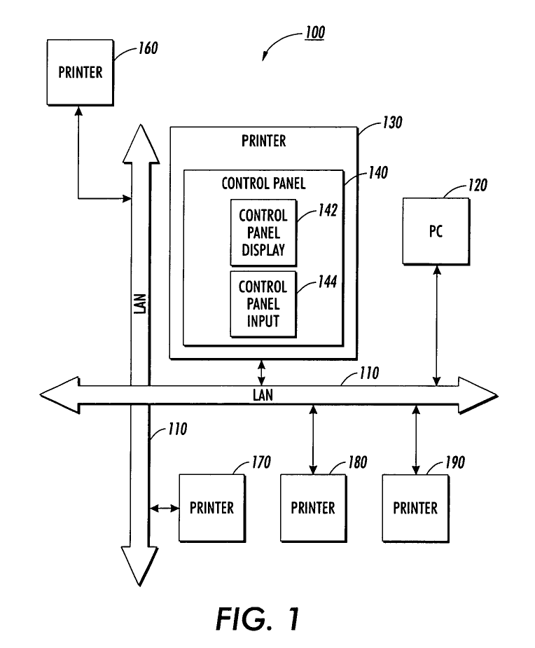

The basic components of the present-inventive print job handling network 100 are shown in FIG. 1. In the illustration, a Local Area Network (LAN) 110 connects several components to the network, such as a computer 120, a server 190, and several network printers (130, 160, 170, 180). It will be appreciated by those skilled in the art that the printer network need not be as shown, but a specialized printer network can be employed. The printers on the specialized network can then communicate with computers and other devices by way of the LAN 110.

A user desiring to print a document can send a print job to one of the network printers. In the embodiment of the present invention, all of the network printers have control panels such as the one numbered 140. However, the present invention can function with less than all of the printers containing such a control panel, although system flexibility is reduced. Upon a user arriving at the location of the printer (for example, 130) a control panel display 142 indicates in the nominal case, whether a print job is being executed, and whether unexecuted print jobs will be able to be executed. The display can also list all of the current print jobs on the particular printer's print queue.

The control panel 140 includes a control panel input or input mechanism 144 having input keys and buttons. It is through the control panel input 144, that a user can cause a print job to be re-routed to the alternate printer of his or her choice (if there is more than one choice), or choose to have the system 100 designate the alternate printer. The user also has the option to choose from multiple print jobs in the print queue to be re-routed.

The control panels of the network printers contain print controllers containing printer control logic for accepting and executing user inputs, and for initiating a print job re-route operation. The print controllers of the several printers can communicate can communicate with each other indirectly through the server 190, or directly using a peer-to-peer approach. Several variations for re-routing a print job are possible, including forwarding a print job directly to an alternate printer (in a peer-to-peer approach), forwarding the print job first through the server 190 and then to the alternate printer, or if the server maintains a copy of the print job until it receives a notification that the job has been executed, forwarding a copy from the server to the alternate printer, as specified by a print controller.

General Algorithm Description

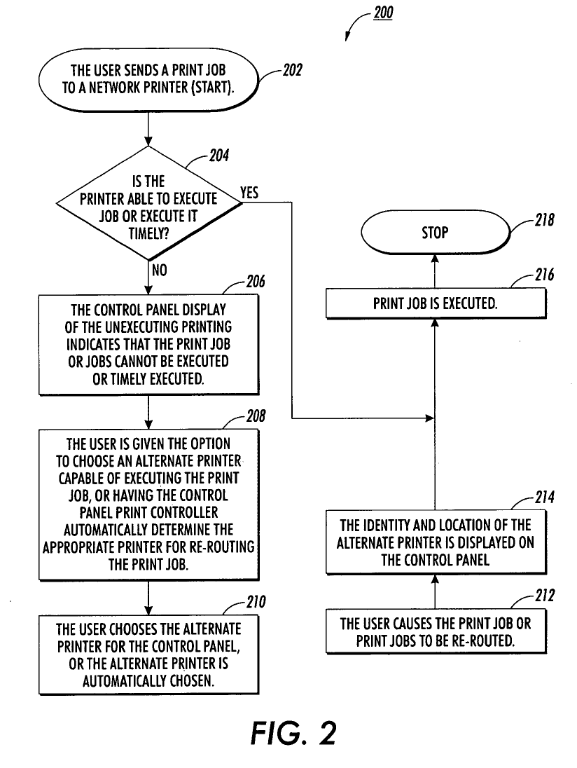

The process or algorithm 200 used by the present invention to allow a user to re-route a print job from one printer to an alternate network printer is illustrated in FIG. 2.

The process/program 200 begins with a network user sending a print job to a network printer in Step 202. In Step 204, the print control logic of the network printer receiving the print job determines whether the printer can still execute the print job. This step assumes that the printer has already accepted the print job. This query can occur periodically after a print job is accepted, but before it is executed. If the print job can be executed, the program jumps to Step 216, where the print job is executed, followed by the end of the program (Step 218).

If the printer cannot execute the print job, or cannot execute it in a predetermined timely manner, the program advances to Step 206, where the control panel display of the printer with the unexecuted print job indicates in a user-perceivable manner that the print job cannot be executed, or cannot be timely executed. In Step 208 the user is given the option to re-route the print job to an alternate network printer of his or her choosing, or instruct the system to automatically re-route the print job to an appropriate network printer. During Step 208, specific information about the capabilities of possible alternate network printers can be displayed. The capabilities can include such aspects as the type (e.g., size) and amount of paper currently loaded in the prospective alternate printer, its estimated printing speed or time for executing the print job, whether it can print in duplex mode, and other finishing options. In Step 210 the user makes one of the choices previously presented in Step 208 via the control panel input.

The print job or print jobs chosen for re-routing are re-routed in Step 212. The control panel display indicates the identity of the alternate printer, along with its physical location in Step 214. The program then advances to previously described Steps 216 and 218 to execute the re-routed print job.

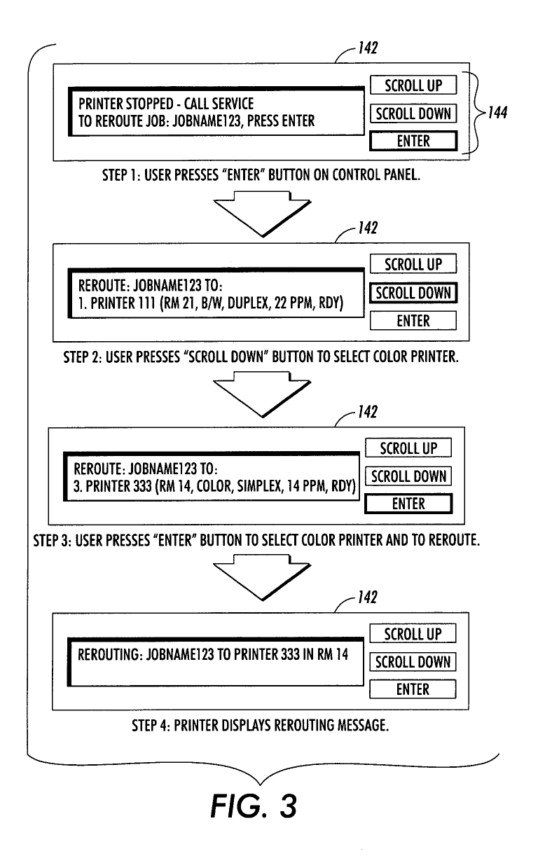

The process is further illustrated with the aid of FIG. 3, which shows a series of control panel displays next to corresponding process steps. In the example, a user has submitted a color print job for execution and discovers upon arriving at the printer that the printer has stopped. Following the instructions of the control panel display 142, the user presses the “ENTER” button from the control panel input 144 to re-route the print job (Step 1). In Step 2, the user presses the “SCROLL DOWN” button to select a color printer for receiving the re-routed print job. In Step 3, the user presses the “ENTER” to activate the print job re-routing operation. Finally, the control panel display 142 acknowledges the re-routing operation in Step 4.

Variations and modifications of the present invention are possible, given the above description. However, all variations and modifications which are obvious to those skilled in the art to which the present invention pertains are considered to be within the scope of the protection granted by this Letters Patent.

1. A print job handling system, said system comprising:
a network adapted to interconnect at least one computer and peripheral devices;
a plurality of network printers coupled to said network, and adapted to execute print jobs; and
at least one printer control panel coupled to at least one of said network printers;
wherein said control panel comprises a control panel display adapted to display information about currently pending print jobs that have been sent to the control panel's associated network printer, along with an indication of the ability of the control panel's associated network printer to execute pending print jobs; and
wherein said control panel comprises an input mechanism adapted to allow a network user to, via said control panel and upon an indication that a print job cannot be executed or executed satisfactory to the user, re-route a print job from the control panel's associated printer to an alternate network printer.

2. The system of claim 1, wherein said alternate network printer supports the capabilities needed to execute the re-routed print job.

3. The system of claim 1, wherein said alternate network printer is the closest geographically of network printers that support the capabilities needed to execute the re-routed print job.

4. The system of claim 1, wherein an indication that a print job cannot be executed satisfactory to the network user comprises a time delay.

5. A print job handling system, said system comprising:
a network adapted to interconnect at least one computer and peripheral devices;
a plurality of network printers coupled to said network, and adapted to execute print jobs; and
at least one printer control panel coupled to at least one of said network printers;
wherein said control panel comprises a control panel display adapted to display information about currently pending print jobs that have been sent to the control panel's associated network printer, along with an indication of the ability of the control panel's associated network printer to execute pending print jobs;
wherein said control panel comprises an input mechanism adapted to allow a network user to, via said control panel and upon an indication that a print job cannot be executed or executed satisfactory to the user, re-route a print job from the control panel's associated printer to an alternate network printer; and
wherein said control panel is adapted to, upon input via said input mechanism by the by the network user, automatically cause a print job re-route to a network printer determined by said system to be appropriate.

6. The system of claim 1, wherein said control panel is adapted to allow a network user to cause a print job re-route to an alternate network printer from a list of network printers displayed by said control panel display.

7. The system of claim 1, wherein said control panel is adapted to allow a network user to cause a print job re-route from a plurality of pending print jobs displayed by said control panel display.

8. The system of claim 1, wherein said control panel display is adapted to display the location of the alternate network printer chosen for executing a re-routed print job.

9. The system of claim 1, wherein said control panel display is adapted to display differences in the capabilities of printer associated with said control panel and other network printers to be considered for re-routing a print job.

10. The system of claim 1, wherein said control panel is adapted to allow a network user to cancel a print job.

11. A print job handling method comprising:
via a network, interconnecting at least one computer and peripheral devices;
coupling to said network, a plurality of network printers adapted to execute print jobs;
via a control panel coupled to at least one of said network printers, displaying information about currently pending print jobs that have been sent to the control panel's associated network printer, along with an indication of the ability of the control panel's associated network printer to execute pending print jobs; and
via said control panel, and upon an indication that a print job cannot be executed or executed satisfactory to the user, allowing a user to re-route a print job from the control panel's associated printer to an alternate network printer.

12. The method of claim 11, wherein said alternate network printer supports the capabilities needed to execute the re-routed print job.

13. The method of claim 11, wherein said alternate network printer is the closest geographically of network printers that support the capabilities needed to execute the re-routed print job.

14. The method of claim 11, wherein an indication that a print job cannot be executed satisfactory to the network user comprises a time delay.

15. The method of claim 11, further comprising:
upon input via said control panel by the network user, automatically re-routing a print job to a network printer determined to be appropriate.

16. The method of claim 11, further comprising;
upon input via said control panel by the network user, re-routing a print job to an alternate network printer from a list of network printers displayed by said control panel.

17. The method of claim 11, further comprising:
upon input via said control panel by the network user, re-routing a print job to an alternate network printer from a plurality of pending print jobs displayed by said control panel.

18. The method of claim 11, further comprising:
via said control panel, displaying the location of the alternate network printer chosen for executing a re-routed print job.

19. The method of claim 11, further comprising:
via said control panel, displaying differences in the capabilities of printer associated with said control panel and other network printers to be considered for re-routing a print job.

20. The method of claim 11, further comprising:
upon input via said control panel by the network user, canceling a print job.
